(19) United States
(12) Patent Application Publication
(10) Pub. No.: US 2021/0207831 A1
(43) Pub. Date: Jul. 8, 2021

(54) REFRIGERANT LEAK DETECTION AND MITIGATION

(71) Applicant: Carrier Corporation, Palm Beach Gardens, FL (US)

(72) Inventors: Richard G. Lord, Murfreesboro, TN (US); Larry D. Burns, Avon, IN (US); Cheng Chen, Avon, IN (US)

(21) Appl. No.: 17/255,212

(22) PCT Filed: Sep. 10, 2020
(86) PCT No.: PCT/US2020/050169

§ 371 Date: Dec. 22, 2020

Related U.S. Application Data
(60) Provisional application No. 62/899,403, filed on Sep. 12, 2019.

(51) Int. Cl. F24F 11/36; F24F 11/77; F24F 11/86

(52) U.S. Cl. CPC F24F 11/36; F24F 2140/12; F24F 11/86; F24F 11/77

(57) ABSTRACT

A method for a refrigeration system according to an example of the present disclosure includes monitoring a performance characteristic of a refrigeration system, and based on the performance characteristic deviating from a predefined expected value by more than a predefined threshold: determining that the refrigeration system is leaking refrigerant, and operating a fan configured to pass air through a heat exchanger of the refrigeration system to dissipate the leaked refrigerant. A refrigeration system is also disclosed that is operable to detect and mitigate refrigerant leaks.

### CROSS-REFERENCE TO RELATED APPLICATIONS

This application claims the benefit of U.S. Provisional Application No. 62/899,403, filed Sep. 12, 2019, the disclosure of which is incorporated herein by reference herein in its entirety.

### BACKGROUND

The present disclosure relates to a refrigeration system, and more particularly a method of detecting and mitigating refrigerant leaks in a refrigeration system.

Buildings, such as commercial buildings including university buildings, office buildings, retail, hospitals, and restaurants and residential buildings including single family, multi-family and high rise residential, and the like, include refrigeration systems which are operable to control the climate inside the building. A typical refrigeration system includes an evaporator, circulating fan, one or more compressors, a condenser, and an expansion valve. This system and components utilize circulating refrigerant to maintain an indoor temperature and humidity of the building at a desired level.

Traditionally, refrigeration systems have used A1 refrigerants, which are non-flammable. However, global warming and other environmental concerns have caused the heating, ventilation, and air conditioning (HVAC) industry to explore alternative lower Global Warming Potential (GWP) refrigerants, such as A2L refrigerants, in place of existing A1 refrigerants in HVAC systems. Although these alternative refrigerants have a lower GWP, they are may be mildly flammable.

### SUMMARY

A method for a refrigeration system according to an example of the present disclosure includes monitoring a performance characteristic of a refrigeration system, and based on the performance characteristic deviating from a predefined expected value by more than a predefined threshold: determining that the refrigeration system is leaking refrigerant, and operating a fan configured to pass air through a heat exchanger of the refrigeration system to dissipate the leaked refrigerant.

In a further embodiment of any of the foregoing embodiments, operating the fan includes operating a plurality of fans instead of a single fan.

In a further embodiment of any of the foregoing embodiments, monitoring the performance characteristic includes monitoring a status of a low pressure device configured to respond to a refrigerant low pressure condition between an outlet of the heat exchanger, which operates as an evaporator, and an inlet to a compressor of the refrigeration system. The performance characteristic comprises a status of or a reading from the low pressure sensor.

In a further embodiment of any of the foregoing embodiments, the refrigeration system is a heat pump, and monitoring the performance characteristic includes monitoring a liquid line loss of charge sensor and comparing a reading from the liquid line loss of charge sensor to the predefined expected value.

In a further embodiment of any of the foregoing embodiments, monitoring the performance characteristic includes determining a subcooling temperature of the refrigeration system, and comparing the subcooling temperature to the predefined expected value to determine whether the subcooling temperature differs by more than the predefined threshold.

In a further embodiment of any of the foregoing embodiments, monitoring the performance characteristic includes determining a superheating temperature of refrigerant entering a compressor of the refrigeration system, and comparing the superheating temperature to the predefined expected value to determine whether the superheating temperature differs by more than the predefined threshold.

In a further embodiment of any of the foregoing embodiments, monitoring the performance characteristic includes monitoring a power consumption of one or more compressors of the refrigeration system, and comparing the power consumption to the predefined expected value to determine whether the power consumption differs by more than the predefined threshold.

In a further embodiment of any of the foregoing embodiments, the compressor is a variable speed compressor, and monitoring the performance characteristic includes monitoring a rotational speed of the variable speed compressor, and comparing the rotational speed to the predefined expected value.

In a further embodiment of any of the foregoing embodiments, the predefined expected value is a predefined valve position of an electronic expansion valve of the refrigeration system, and monitoring the performance characteristic includes determining a current valve position of the electronic expansion valve, and determining whether a difference between the current valve position and the predefined valve position differs by more than the predefined threshold.

In a further embodiment of any of the foregoing embodiments, monitoring the performance characteristic includes performing machine learning using a neural network to determine the predefined expected value of a parameter of the refrigeration system based on historical data. The parameter includes a duration of ON cycles of the compressor, a duration of OFF cycles of the compressor, a frequency of said ON cycles, or a frequency of said OFF cycles. The method includes determining a current value of the parameter based on operational data of the refrigeration system, and comparing the current value to the predefined expected value.

A refrigeration system according to an example of the present disclosure includes a compressor configured to compress refrigerant, an expansion device configured to reduce a temperature and pressure of the a refrigerant, a heat exchanger configured to receive refrigerant from one of the compressor and expansion device, exchange heat with the refrigerant, and provide the refrigerant to the other of the compressor and expansion device. A controller is operable to monitor a performance characteristic of a refrigeration system, and based on the performance characteristic deviating from a predefined expected value by more than a predefined threshold: determine that the refrigeration system is leaking refrigerant, and operate a fan configured to pass air through the heat exchanger to dissipate the leaked refrigerant.

In a further embodiment of any of the foregoing embodiments, the controller is configured to operate a plurality of fans instead of a single fan, based on the performance characteristic deviating from the predefined expected value by more than the predefined threshold.

In a further embodiment of any of the foregoing embodiments, to monitor the performance characteristic, the controller is configured to: monitor a status of a low pressure device configured to respond to a refrigerant low pressure condition between an outlet of the heat exchanger, which operates as and an inlet to a compressor of the refrigerant system; and the performance characteristic includes a status of the low pressure switch or a reading from the low pressure device.

In a further embodiment of any of the foregoing embodiments, the refrigeration system includes a heat pump, and to monitor the performance characteristic, the controller is configured to monitor a liquid line loss of charge sensor, and compare a reading from the liquid line loss of charge sensor to the predefined expected value.

In a further embodiment of any of the foregoing embodiments, to monitor the performance characteristic, the controller is configured to determine a subcooling temperature of the refrigeration system, and compare the subcooling temperature to the predefined expected value to determine whether the subcooling temperature differs by more than the predefined threshold.

In a further embodiment of any of the foregoing embodiments, to monitor the performance characteristic, the controller is configured to determine a superheating temperature of refrigerant entering a compressor of the refrigeration system, and compare the superheating temperature to the predefined expected value to determine whether the superheating temperature differs by more than the predefined threshold.

In a further embodiment of any of the foregoing embodiments, to monitor the performance characteristic, the controller is configured to monitor a power consumption of one or more compressors of the refrigeration system, and compare the power consumption to the predefined expected value to determine whether the power consumption differs by more than the predefined threshold.

In a further embodiment of any of the foregoing embodiments, the compressor is a variable speed compressor, and to monitor the performance characteristic, the controller is configured to monitor a rotational speed of the variable speed compressor, and compare the rotational speed to the predefined expected value.

In a further embodiment of any of the foregoing embodiments, the expansion device is an electronic expansion valve, and to monitor the performance characteristic, the controller is configured to determine a current valve position of the electronic expansion valve, and determine whether a difference between the current valve position and the predefined valve position differs by more than the predefined threshold.

In a further embodiment of any of the foregoing embodiments, to monitor the performance characteristic, the controller is configured to perform machine learning using a neural network to determine the predefined expected value of a parameter of the refrigeration system based on historical data, the parameter including a duration of ON cycles of the compressor, a duration of OFF cycles of the compressor, a frequency of said ON cycles, or a frequency of said OFF cycles. The controller is configured to determine a current value of the parameter based on operational data of the refrigeration system, and compare the current value to the predefined expected value.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 is a schematic view of an example refrigeration system which is a cooling system.

FIG. 2 is a schematic view of an example refrigeration system that utilizes a heat pump.

FIG. 3 is a schematic view of an example electronic expansion valve.

FIG. 4 is a flowchart illustrating an example method for detecting and mitigating refrigerant leaks.

FIG. 5 is a schematic view of a controller for a refrigeration system.

### DETAILED DESCRIPTION

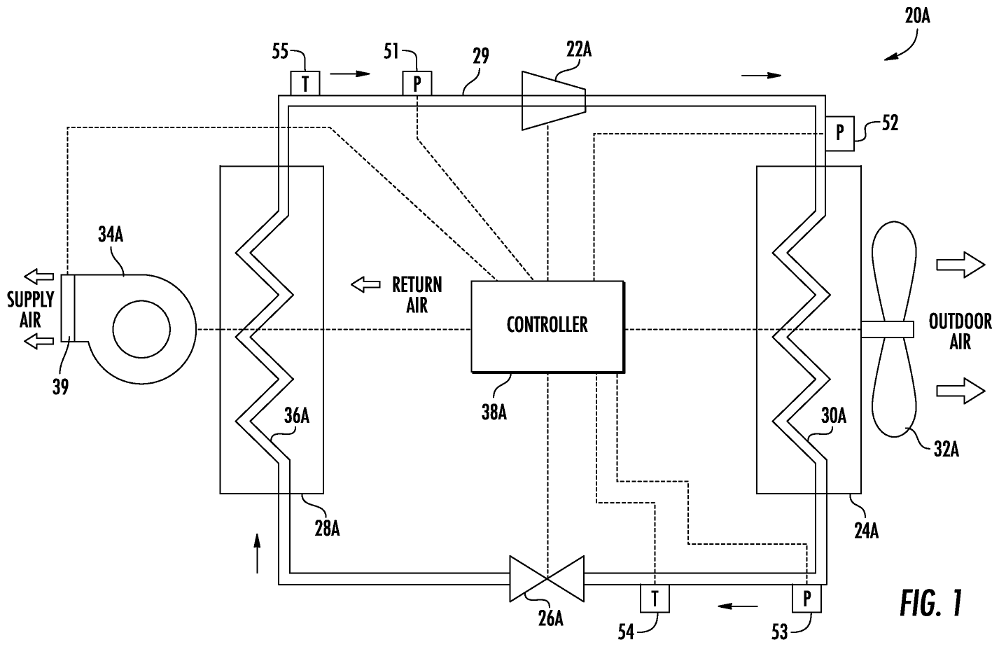

FIG. 1 is a schematic view of an example refrigeration system 20A that includes a compressor 22A, a first heat exchanger 24A, an expansion device 26A, and a second heat exchanger 28A. The compressor 22A could include one or more variable speed compressors or one or more non-variable speed compressors. Refrigerant in a suction line 29 is compressed in the compressor 22A, and exits the compressor 22A at a high pressure, high temperature, and a high enthalpy, and flows to the first heat exchanger 24A. Although only a single compressor 22A is shown, it is understood that multiple compressors could be used.

In a cooling operation, the first heat exchanger 24A operates as a condenser that rejects heat. In the first heat exchanger 24A, refrigerant flows through one or more coil tubes 30A and rejects heat to air that is drawn over the coil tube(s) 30A by a fan 32A. In the first heat exchanger 24A, refrigerant is condensed into a liquid that exits the first heat exchanger 24A at a low enthalpy and a high pressure. The heat rejection medium could be ambient air or could be water in a shell and tube arrangement, for example.

The refrigerant flows from the first heat exchanger 24A to the expansion device 26A, such as a thermostatic expansion valve or electronic expansion valve. The expansion device 26A reduces the refrigerant to a low pressure and temperature. After expansion, the refrigerant flows through the second heat exchanger 28A, which operates as an evaporator that accepts heat. A blower fan 34A (which may be a centrifugal fan) draws air through the second heat exchanger 28A and over a coil refrigerant tubes 36A. The refrigerant flowing through the coil refrigerant tubes 36A and accepts heat from air, exiting the second heat exchanger 28A at a high enthalpy and a low pressure. The refrigerant then flows to the compressor 22A, completing its refrigeration cycle. The cooling medium could be air or could be water in a shell and tube arrangement, for example.

A controller 38A controls operation of each of the compressor 22A, fan 32A, and fan 34A and operates each of these components during a heat exchange mode when the refrigeration system 20A is running. In the heat exchange mode, the refrigeration system 20A is operated to cool and dehumidify air. In embodiments utilizing an electronic expansion valve for the expansion device 26A, the controller 38A could also control the expansion device 26A, and operate the expansion device 26A in the heat exchange mode.

Optionally, an auxiliary heating device 39 (e.g., a gas or electric heating device—not shown) may be provided to provide for heating during certain conditions (e.g., winter operation), and could also be controllable by the controller 38.

A low pressure device 51 is in communication with the controller 38A and is operable to respond to refrigerant low pressure condition in the suction line 29 if the refrigerant has fallen beneath a predefined low pressure threshold. The low pressure device 51 could be a switch configured to changed states in response to the pressure falling below a predefined low pressure threshold (e.g., turn ON or OFF in response to such a condition), or could be a sensor (e.g., a pressure transducer) operable to provide a sensor reading indicative of the pressure value, for example.

A high side pressure sensor 52, liquid line pressure transducer 53, temperature sensor 54, and temperature sensor 55 are also each in communication with the controller 38A. The high side pressure sensor 52 is operable to measure a pressure of refrigerant entering the first heat exchanger 24A from the compressor 22A. The liquid line pressure transducer 53 is operable to measure a pressure of refrigerant existing the first heat exchanger 24A on its way to the expansion device 26A. The temperature sensor 54 is operable to measure a temperature of refrigerant between the first heat exchanger 24A and expansion device 26A. The temperature sensor 55 is operable to measure a temperature of refrigerant between the second heat exchanger 28A and the compressor 22A.

The controller 38A is operable to use input from the sensors 53, 54 to determine a subcooling temperature of the refrigeration system 20A in a process known in the art, based on a difference between a temperature of refrigerant leaving the first heat exchanger 24A and a saturation bubble point for the refrigerant.

Alternatively, or in addition to being able to determine the subcooling temperature, the controller 38A is operable to use input from the sensors 55, 51 to determine a superheating temperature of refrigerant entering the compressor 22 of the refrigeration system 20A in a process known in the art, based on a difference between a temperature of refrigerant entering the compressor 22 and a refrigerant saturation dewpoint.

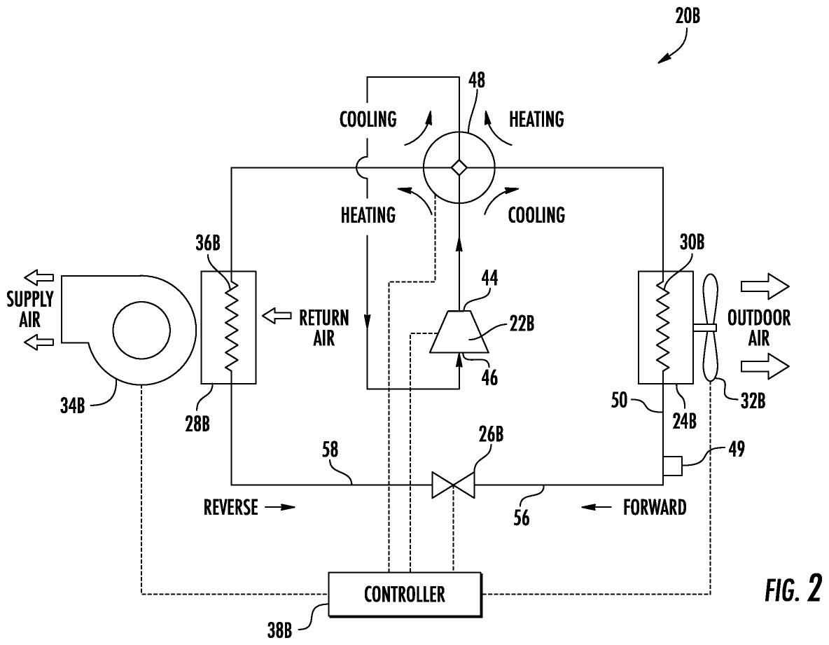

FIG. 2 illustrates another type of refrigeration system, which is a heat pump 20B, capable of operating in both cooling and heating modes. The heat pump 20B includes a compressor 22B (which could also be variable speed or non-variable speed) that delivers refrigerant through a discharge port 44 that is returned back to the compressor 22B through a suction port 46. Although only a single compressor 22B is shown, it is understood that multiple compressors could be used.

Refrigerant moves through a four-way valve 48 that can be switched between heating and cooling positions to direct the refrigerant flow in a desired manner (indicated by the arrows associated with valve 48 in FIG. 2) depending upon the requested mode of operation, as is well known in the art. When the valve 48 is positioned in the cooling position, refrigerant flows from the discharge port 44 through the valve 48 to an outdoor heat exchanger 24B, which includes a coil 30B, and where heat from the compressed refrigerant is rejected to a secondary fluid, such as ambient air. A fan 32B is used to provide airflow through the outdoor heat exchanger 24B.

The refrigerant flows from the outdoor heat exchanger 24B through a first fluid passage 56 into an expansion device 26B, which can be a thermostatic expansion valve or electronic expansion valve, for example. The refrigerant when flowing in this forward direction expands as it moves from the first fluid passage 56 to a second fluid passage 58 thereby reducing its pressure and temperature. The expanded refrigerant flows through an indoor heat exchanger 28B, which includes a coil 36B, to accept heat from another secondary fluid and supply cold air indoors. A fan 34B (which may be a centrifugal fan) provides air flow through the heat exchanger 28B. The refrigerant returns from the indoor exchanger 28B to the suction port 46 through the valve 48.

When the valve 48 is in the heating position, refrigerant flows from the discharge port 44 through the valve 48 to the indoor heat exchanger 28B where heat is rejected to the indoors. The refrigerant flows from the indoor heat exchanger 28B through second fluid passage 58 to the expansion device 26B. As the refrigerant flows in this reverse direction from the second fluid passage 58 through the expansion device 26B to the first fluid passage 56, the refrigerant flow is more restricted in this direction as compared to the forward direction. The refrigerant flows from the first fluid passage 56 through the outdoor heat exchanger 24B, four-way valve 48 and back to the suction port 46 through the valve 48.

A controller 38B controls operation of each of the compressor 22B, fan 32, fan 34B, and valve 48 when the heat pump 20B is operating in a heating or cooling mode. In embodiments utilizing an electronic expansion valve for the expansion device 26B, the controller 38B would also control the expansion device 26B while the heat pump 20B is operating in a heating or cooling mode.

The refrigeration system 20B includes a liquid line loss of charge sensor 49 operable to detect a significant loss of charge in the liquid line 50 (e.g., 80% or more of a loss of charge). Also, although not shown in FIG. 2, the refrigeration system 20B could also include sensors similar to the sensors 51, 53, 54, 55 for measuring subcooling temperature and/or superheating temperature, as is known in the art.

The refrigeration system 20 can be used in a number of applications, such as in residential systems, rooftop systems, and air cooled chillers. When used with a residential system, the heat exchanger 28 is located inside a residence and the fan 34 draws air through the heat exchanger 28. Also, when used in the residential system, the heat exchanger 24 is located outside the residence.

When used with a roof top system, the refrigeration system 20 is located on a rooftop or an exterior of a building. In this configuration, refrigeration system 20 includes an evaporator section that draws air from inside the building and conditions it with the heat exchanger 28 and directs the air back into the building. Additionally, the refrigeration system 20 for the rooftop application would include an outdoor section with the fan 32 drawing ambient air through the heat exchanger 24 to remove heat from the heat exchanger 24 as described above.

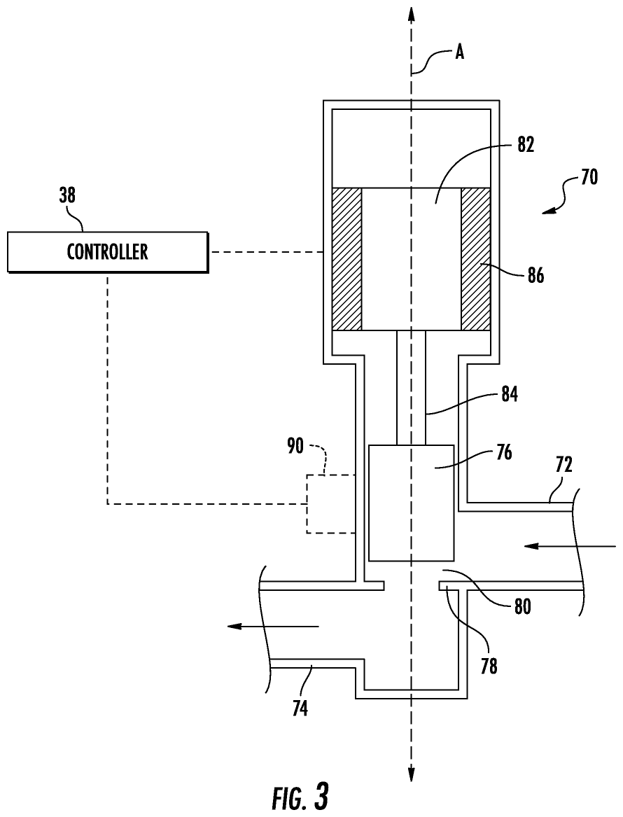

FIG. 3 is a schematic view of an example electronic expansion valve (“EXV”) 70 that can be used as the expansion device 26 in the refrigeration system 20. The EXV 70 includes a refrigerant inlet 72 and a refrigerant outlet 74. A valve plug 76 is movable along a central longitudinal axis A relative to a valve seat 78 to form a gap 80 for refrigerant to flow from the inlet 72 to the outlet 74. A size of the gap 80 depends on a distance between the valve plug 76 and the valve seat 78.

The valve plug 76 is connected to a permanent magnet 82 via a lead screw shaft 84. The controller 38 is operable to energize coils 86 which surround the permanent magnet 82 to selectively move the permanent magnet 82 and valve plug 76 along the central longitudinal axis A. The coils 86 and permanent magnet 82 are part of a stepper motor which can be used to track the position of the valve plug 76 and a size of the gap 80. The permanent magnet 82 and coils 86 collectively form a stepper motor. By selectively energizing the coils 86, the controller 38 can control a position of the valve plug 76 relative to the valve seat 78 (e.g., 40% open, 60% open, etc.).

It is understood that the electronic expansion valve 70 of FIG. 3 is a non-limiting example, and that other types of electronic expansion valves could be used, such as a slot orifice assembly or needle valve.

The controller 38 is operable to determine a position of the valve plug 76 based on an amount of voltage provided to the coils 86 and/or based on a position sensor 90 configured to measure a position of the valve plug 76. Such sensors 90 are known in the art and are therefore not discussed in detail herein.

Charging a refrigeration system refers to the addition of refrigerant to the refrigeration system. The term “loss of charge” is another way of referring to the loss of refrigerant from a refrigeration system due to leakage. Loss of charge is undesirable because the refrigeration system will begin to work harder to achieve a target temperature and/or may be unable to reach the target temperature. Loss of charge is also undesirable because leaked refrigerants contribute to global warming and because some lower GWP refrigerants may also be mildly flammable.

Standards and codes will require a direct measurement refrigerant sensor for systems using A2L refrigerants. These sensor and controls for a full detector system are being developed and may make use of chemical sensing sensors using technologies like NDIR and MOS sensor, however, such sensors are most effective when the system is off and there is a major leak. Below, a variety of techniques are disclosed for detecting refrigerant slow leaks based on a performance characteristic of a refrigeration system. These techniques are suitable for use while a refrigeration system 20 is running, and would provide improvements over use of the refrigerant sensors discussed above. Shutdown of a running refrigeration system would not be required for accurate detection. Also, these techniques could be used to provide redundancy to traditional refrigerant sensor as well as providing means to monitor slow losses of refrigerant over time.

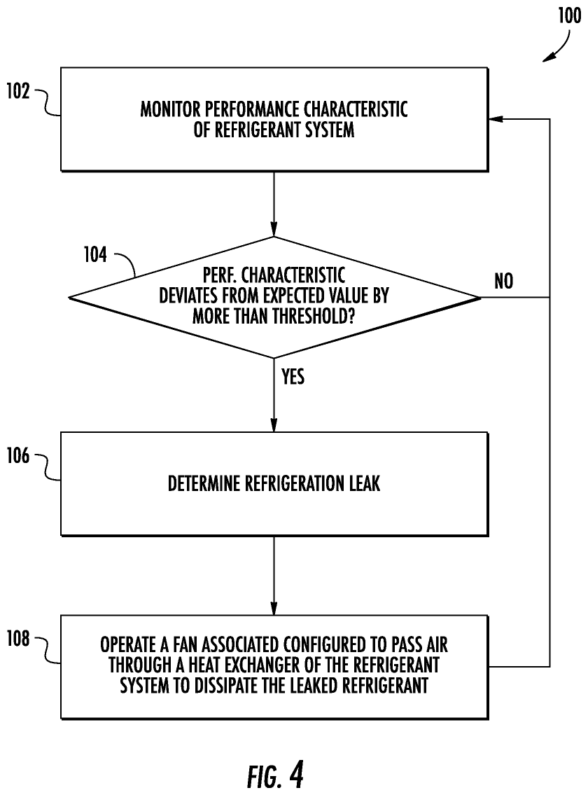

FIG. 4 is a flowchart illustrating an example method 100 for detecting refrigerant leaks. The method 100 can be implemented by the controller 38. The controller monitors a performance characteristic of the refrigeration system 20 (step 102), and determines whether the performance characteristic deviates from a predefined expected value by more than a predefined threshold (step 104). If the deviation is less than the predefined threshold (a “no” to step 104), the controller 38 resumes monitoring of the performance characteristic (step 102).

Otherwise, if the performance characteristic does deviate from the expected value by more than the predefined threshold (a “yes” to step 104), the controller determines that the refrigeration system 20 has leaked refrigerant (step 106), and will enable mitigation which involves operating a fan (fan 32 and/or 34) associated with a heat exchanger (24 and/or 28) of the refrigeration system to dissipate the leaked refrigerant (step 108). Thus, in one example, one of the fans 32, 34 is operated for mitigation, and in another example both of the fans 32, 34 are operated for mitigation. As discussed above, the fan 32 could include multiple fans, and the fan 34 could include multiple fans. In one example, step 108 includes operating the fans 32 and/or the fans 34. Operating the fan(s) 32, 34 circulates air through ductwork and potentially also a building that utilizes the ductwork, which dissipates and dilutes leaking/leaked refrigerant (e.g., below flammable limits). As part of step 108, the controller 38 disables the compressor 22 and optionally also disables potential ignition sources, such as the auxiliary heating device 39.

A variety of different performance characteristics can be monitored as part of the method 100, as described below. The controller 38 may be configured to perform the method 100 for a single one of the performance characteristics, or for any combination of the performance characteristics.

In one embodiment, the performance characteristic is a status of the low pressure device 51, and the controller 38 is configured to compare a status of or reading from the low pressure device 51 to an expected status or value in step 104, and determine a refrigerant leak based on a difference between those values. The change in status could include the low pressure switch 40 switching from an expected “on” state to a detected “off” state, or vice versa, in one example. In one example, the reading from the low pressure device 51 includes a change in pressure measurements from an expected value range to an unexpected value range.

In one embodiment, the performance characteristic is a reading from the liquid line loss of charge sensor 49, and the controller 38 is configured to compare a reading from the liquid line loss of charge sensor 49 to an associated predefined expected value in step 104.

In one embodiment, the performance characteristic is a subcooling temperature of the refrigeration system 20, and the controller 38 is configured to compare the subcooling temperature to an expected subcooling temperature to determine whether the subcooling temperature differs by more than the predefined expected value in step 104. This is a useful detection method because a loss of charge accompanies a loss of subcooling.

In one embodiment, the performance characteristic is a superheating temperature of the refrigeration system 20, and the controller 38 is configured to compare the superheating temperature to the predefined expected value to determine whether the superheating temperature differs changed by more than the predefined threshold in step 104.

In one embodiment, the performance characteristic is a power consumption of one or more compressors of the refrigeration system, and the controller 38 is configured to compare the power consumption to the predefined expected value to determine whether the power consumption differs by more than the predefined threshold in step 104. An increased power consumption can be evidence of a refrigerant leak because the system is working harder to achieve the same level or a diminished level of thermal conditioning.

In one embodiment, compressor 22 is a variable speed compressor, and the performance characteristic is a rotational speed of the variable speed compressor. The controller 38 is configured to compare the measured rotational of the compressor 22 to an expected rotational speed in step 104, as an abnormally increased rotational speed can be evidence that the compressor 22 is working harder to achieve the same level or a diminished level of thermal conditioning.

In one embodiment, the performance characteristic is a position of the EXV 70. The controller 38 is configured to compare a position of the EXV 70 to an expected position to see if the EXV 70 is open abnormally wide (e.g., 60% open when the EXV 70 is normally 40% open) in step 104. An EXV 70 that is open wider than normal can be evidence of a refrigerant leak because the EXV 70 is opening wider to try to increase the flow of refrigerant from its inlet 72 to its outlet 74.

In one embodiment, performance characteristic includes one or more of: a duration of ON cycles of the compressor, a duration of OFF cycles of the compressor, a frequency of said ON cycles, or a frequency of said OFF cycles. In this example, the controller 38 is operable to perform machine learning using a neural network to determine the predefined expected value of the parameter based on historical data of the refrigeration system 20. Machine learning is useful here because the expected values can vary based on a number of factors, such as building size, level of insulation in a building, window placement in the building, geographic location of the building, ambient temperature, etc. In one example, the historical data corresponds to a time period when there is likely to be a consistent number of building occupants (e.g., between 2 AM-5 AM as most occupants will be inactive) instead of between 6 PM-8 PM where visitors may be present). The controller 38 determines a current value of the parameter based on operational data of the refrigeration system 20, and compare the current value to the predefined expected value in step 104. If the refrigeration system 20 is cycling ON more frequently and/or for longer durations, this can be evidence of a refrigerant leak because the refrigeration system 20 is working harder to achieve the same level or a diminished level of thermal conditioning.

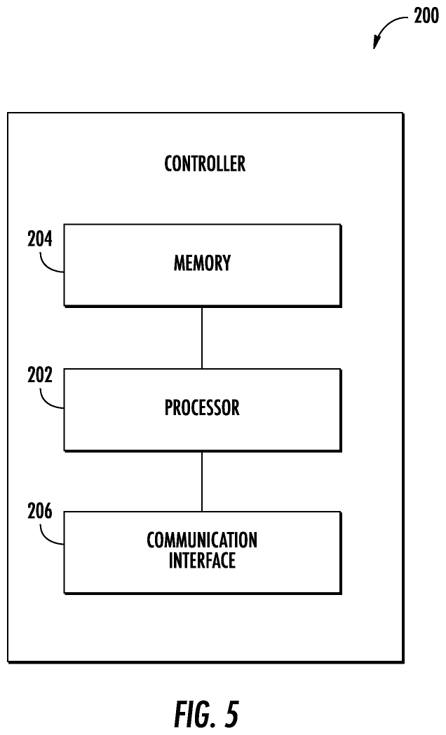

FIG. 5 is a schematic view of a controller 200 that can be used as either of the controllers 38A-B. The controller 200 includes a processor 202 that is operatively connected to memory 204 and a communication interface 206. The processor 202 may include one or more microprocessors, microcontrollers, application specific integrated circuits (ASICs), or the like, for example.

The memory 204 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory 204 may incorporate electronic, magnetic, optical, and/or other types of storage media. The memory 204 can also have a distributed architecture, where various components are situated remotely from one another, but can be accessed by the processor 202. The memory 204 could be used to store any one or combination of the following: the various predefined thresholds described above, a pressure to saturation temperature conversion chart for use in determining the subcooling, a neural network for determining the duration and/or frequency of ON/OFF cycles and/or the speed of the compressor (if it is a variable speed compressor) of the compressor 22, and historical operational data of the refrigeration system.

The communication interface 206 is configured to facilitate communication between the controller 200 and some or all of the compressor 22, fans 32 and/or 34, expansion device 26 (if it is an electronic device), and the various sensors discussed herein. In one example, multiple controllers 200 are included (e.g., one controller for general operation of the refrigeration system 20 in the heat exchanging mode, and one controller for performing the method 100). In one example, the communication interface 206 includes a wireless interface for wireless communication and/or a wired interface for wired communications.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A method for a refrigeration system, comprising:
monitoring a performance characteristic of a refrigeration system;
based on the performance characteristic deviating from a predefined expected value by more than a predefined threshold:
determining that the refrigeration system is leaking refrigerant; and
operating a fan configured to pass air through a heat exchanger of the refrigeration system to dissipate the leaked refrigerant.

2. The method of claim 1, wherein said operating a fan comprises operating a plurality of fans instead of a single fan.

3. The method of claim 1, wherein said monitoring the performance characteristic comprises:
monitoring a status of a low pressure device configured to respond to a refrigerant low pressure condition between an outlet of the heat exchanger, which operates as an evaporator, and an inlet to a compressor of the refrigeration system; and
wherein the performance characteristic comprises a status of or reading from the low pressure device.

4. The method of claim 1, wherein the refrigeration system is a heat pump, and said monitoring the performance characteristic comprises:
monitoring a liquid line loss of charge sensor; and
comparing a reading from the liquid line loss of charge sensor to the predefined expected value.

5. The method of claim 1, wherein said monitoring the performance characteristic comprises:
determining a subcooling temperature of the refrigeration system; and
comparing the subcooling temperature to the predefined expected value to determine whether the subcooling temperature differs by more than the predefined threshold.

6. The method of claim 1, wherein said monitoring the performance characteristic comprises:
determining a superheating temperature of refrigerant entering a compressor of the refrigeration system; and
comparing the superheating temperature to the predefined expected value to determine whether the superheating temperature differs by more than the predefined threshold.

7. The method of claim 1, wherein said monitoring the performance characteristic comprises:
monitoring a power consumption of one or more compressors of the refrigeration system; and
comparing the power consumption to the predefined expected value to determine whether the power consumption differs by more than the predefined threshold.

8. The method of claim 1, wherein the compressor is a variable speed compressor, and said monitoring the performance characteristic comprises:
monitoring a rotational speed of the variable speed compressor; and
comparing the rotational speed to the predefined expected value.

9. The method of claim 1, wherein:
the predefined expected value is a predefined valve position of an electronic expansion valve of the refrigeration system; and
said monitoring the performance characteristic comprises:
determining a current valve position of the electronic expansion valve; and
determining whether a difference between the current valve position and the predefined valve position differs by more than the predefined threshold.

10. The method of claim 1, wherein said monitoring the performance characteristic comprises:
performing machine learning using a neural network to determine the predefined expected value of a parameter of the refrigeration system based on historical data, the parameter comprising a duration of ON cycles of the compressor, a duration of OFF cycles of the compressor, a frequency of said ON cycles, or a frequency of said OFF cycles;
determining a current value of the parameter based on operational data of the refrigeration system; and
comparing the current value to the predefined expected value.

11. A refrigeration system comprising:
a compressor configured to compress refrigerant;
an expansion device configured to reduce a temperature and pressure of the refrigerant;
a heat exchanger configured to receive refrigerant from one of the compressor and expansion device, exchange heat with the refrigerant, and provide the refrigerant to the other of the compressor and expansion device; and
a controller operable to:
monitor a performance characteristic of the refrigeration system;
based on the performance characteristic deviating from a predefined expected value by more than a predefined threshold:
determine that the refrigeration system is leaking refrigerant; and
operate a fan configured to pass air through the heat exchanger to dissipate the leaked refrigerant.

12. The refrigeration system of claim 11, wherein the controller is configured to operate a plurality of fans instead of a single fan, based on the performance characteristic deviating from the predefined expected value by more than the predefined threshold.

13. The refrigeration system of claim 12, wherein to monitor the performance characteristic, the controller is configured to:
monitor a status of a low pressure device configured to respond to a refrigerant low pressure condition between an outlet of the heat exchanger, which operates as an evaporator, and an inlet to a compressor of the refrigeration system; and
wherein the performance characteristic comprises a status of or reading from the low pressure sensor.

14. The refrigeration system of claim 1, wherein the refrigeration system includes a heat pump, and to monitor the performance characteristic, the controller is configured to:
monitor a liquid line loss of charge sensor; and
compare a reading from the liquid line loss of charge sensor to the predefined expected value.

15. The refrigeration system of claim 11, wherein to monitor the performance characteristic, the controller is configured to:
determine a subcooling temperature of the refrigeration system; and
compare the subcooling temperature to the predefined expected value to determine whether the subcooling temperature differs by more than the predefined threshold.

16. The refrigeration system of claim 11, wherein to monitor the performance characteristic, the controller is configured to:
determine a superheating temperature of refrigerant entering a compressor of the refrigeration system; and
compare the superheating temperature to the predefined expected value to determine whether the superheating temperature differs by more than the predefined threshold.

17. The refrigeration system of claim 11, wherein to monitor the performance characteristic, the controller is configured to:
monitor a power consumption of one or more compressors of the refrigeration system; and
compare the power consumption to the predefined expected value to determine whether the power consumption differs by more than the predefined threshold.

18. The refrigeration system of claim 11, wherein the compressor is a variable speed compressor, and to monitor the performance characteristic, the controller is configured to:
monitor a rotational speed of the variable speed compressor; and
compare the rotational speed to the predefined expected value.

19. The refrigeration system of claim 11, wherein:
the expansion device is an electronic expansion valve; and
to monitor the performance characteristic, the controller is configured to:
determine a current valve position of the electronic expansion valve; and
determine whether a difference between the current valve position and the predefined valve position differs by more than the predefined threshold.

20. The refrigeration system of claim 11, wherein to monitor the performance characteristic, the controller is configured to:
perform machine learning using a neural network to determine the predefined expected value of a parameter of the refrigeration system based on historical data, the parameter comprising a duration of ON cycles of the compressor, a duration of OFF cycles of the compressor, a frequency of said ON cycles, or a frequency of said OFF cycles;
determine a current value of the parameter based on operational data of the refrigeration system; and
compare the current value to the predefined expected value.
